(19) United States
(12) Patent Application Publication
(10) Pub. No.: US 2006/0094445 A1
(43) Pub. Date: May 4, 2006

(54) Method and apparatus of restricting data access

(75) Inventor: Seong Woo Park, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: PANTECH CO., LTD.

(21) Appl. No.: 11/261,318

(22) Filed: Oct. 28, 2005

(30) Foreign Application Priority Data
Oct. 28, 2004 (KR) 10-2004-0086612

(51) Int. Cl. H04Q 7/20

(52) U.S. Cl. 455/456.2

(57) ABSTRACT

Disclosed are method and apparatus of restricting a data access. In particular, disclosed are method and apparatus for restricting an access to downloaded data to be possible only in permitted area or permitted time. A method for restricting data access of the invention, comprising: downloading data having information about an accessible area and a neighboring range of the area to a mobile communication terminal; reading-out the area and the neighboring range information from the data and checking a current position of the mobile communication terminal when a user requests an access for the downloaded data; and accessing to the data if the mobile communication terminal is located on the accessible area. According to the invention, it is also possible to induce the user into specific area in which the access to the data is possible, in specific time.

### CROSS-REFERENCE TO RELATED APPLICATION

The present application is claiming priority of Korean Patent Application No. 10-2004-0086612, filed on Oct. 28, 2004, the content of which is herein incorporated by reference.

### BACKGROUND OF THE INVENTION

1. Field of the Invention

The present invention relates to a method and an apparatus of restricting a data access, and more particularly to a method and an apparatus of allowing a data access to be possible only in permitted region or time when a user of a mobile communication terminal having downloaded the data requests the data access.

2. Background of the Related Art

In recent years, as wireless data communications through a mobile communication network have been activated, diverse data services have been provided. Among the wireless data communication services, there is a service allowing a user of a mobile communication terminal, such as portable communication equipment, cellular phone, PDA, PCS and the like, to download data, for example contents, moving pictures, images, voices, sounds and applications through the mobile communication network and to access the downloaded data in the mobile communication terminal.

The data download through the mobile communication network is allowable anytime and anywhere in which the mobile communication service is provided. As a roaming region of the mobile communication service is gradually spread out, it becomes to possible to provide the data download service globally.

However, as described above, since the data download service is allowable anytime and anywhere in which the mobile communication service is provided, even important data that should not be opened in another region can be downloaded and accessed.

For example, when data important in an enterprise is downloaded and accessed in the mobile communication terminal, the data can be downloaded and accessed anytime and anywhere in which the mobile communication service is provided, although the data is a confidential material and thus should not be leaked out, so that the data may not be protected. In other words, according to the prior art, it is impossible to prevent specific data from being accessed at a time or region in which the specific data should not be accessed. There is a need of method for allowing a user of a mobile communication terminal to data access in specific time or/and specific region.

In addition, there is needed a method of inducing a user into a specific time or region, in which an access of the specific data is permitted, to execute the specific data, thereby managing the specific data more efficiently.

### SUMMARY OF THE INVENTION

Accordingly, the present invention has been made to solve the above problems of the prior art. An object of the present invention is to provide a method and an apparatus of restricting an access of downloaded data temporally or regionally when specific data are downloaded and accessed in a mobile communication terminal, thereby causing a data access to be impossible beyond permitted region and time.

In addition, another object of the invention is to restrict an access of downloaded data temporally or regionally when specific data is downloaded and accessed in a mobile communication terminal, thereby inducing a user of the terminal who wants to access the specific data to move into a specific time or region.

In order to achieve the above objects, there is provided a method for restricting data access comprising processes of: downloading data having information about an accessible area and information about a neighboring range of the area inserted therein to a mobile communication terminal; reading-out the area information and the neighboring range information from the data and checking a current position of the mobile communication terminal when a user requests an access for the downloaded data; and accessing to the data if the mobile communication terminal is located on the accessible area as a result of the check.

According to a second embodiment of the invention, there is provided a method for restricting data access comprising processes of: downloading data having information about an accessible area and information about a neighboring range of the area inserted therein to a mobile communication terminal; notifying the presence of the data to a user when the mobile communication terminal having the data downloaded thereto enters the neighboring range; and accessing to the data when the user moves to the accessible area.

According to a third embodiment of the invention, there is provided a method for restricting data access comprising processes of: downloading data having information about an accessible time inserted therein to a mobile communication terminal; reading-out the time information inserted in the corresponding data to check a current time when a user requests an access for the downloaded data; and accessing to the data when the current time corresponds to the accessible time as a result of the check.

According to a fourth embodiment of the invention, there is provided a method for restricting data access comprising processes of: downloading data having information about an accessible time and information about a neighboring time of the accessible time inserted therein to a mobile communication terminal; notifying the presence of the data to a user when the neighboring time comes; and accessing to the data when the accessible time comes, if the user having received the notification of the presence of the data requests an access of the data.

According to another aspect of the invention, there is provided a data access restricting apparatus comprising: an input section for inputting access restriction information; a data process section for encoding and inserting the access restriction information received from the input section into data for which it is intended to restrict an access; a database for storing the data having the access restriction information inserted therein; and a control section for extracting and transmitting the data having the access restriction information inserted therein, when it is requested a download for the data, from the database to a mobile communication terminal having requested the download, wherein the data having the access restriction information inserted therein is able to be accessed only in case an access condition included in the access restriction information is satisfied, when an access to the data is requested.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view of a mobile communication system for embodying a method for restricting data access according to an embodiment of the invention;

FIG. 2 is a flow chart showing a method for restricting data access according to a first embodiment of the invention;

FIG. 3 is a flow chart showing a method for restricting data access according to a second embodiment of the invention;

FIG. 4 is a flow chart showing a method for restricting data access according to a third embodiment of the invention;

FIG. 5 is a flow chart showing a method for restricting data access according to a fourth embodiment of the invention; and

FIG. 6 is a block diagram showing a structure of a data access restricting apparatus according to an embodiment of the invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

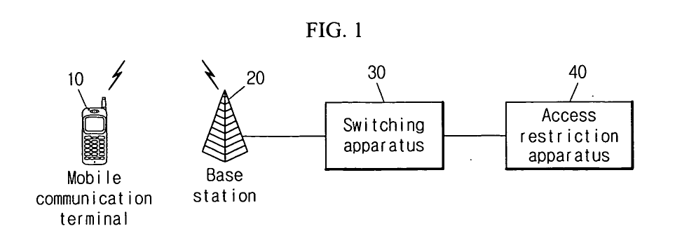

According to an embodiment of the invention, a mobile communication system for embodying a method for restricting data access may comprise a mobile communication terminal 10, a base station 20, a switching apparatus 30 and an access restricting apparatus 40, as shown in FIG. 1.

The mobile communication terminal 10 transmits a download request message of requesting a download of data, which is selected by a user, to the base station 20, and receives access restriction information for the data requested, i.e., accessible area or time information and neighboring range information of the accessible area or time and a message asking a user whether the user agrees to an access restriction of the requested data through the base station 20. Then, the mobile communication terminal notifies a user of the access restriction information through voice output means or image output means and asks the user whether or not the agreement to the access restriction. When the user replies to the question of whether or not the agreement to the access restriction through an input key and the like provided to the mobile communication terminal, the terminal transmits the reply message (i.e., agreement message or refusal message) to the base station 20. If the user does not agree to the access restriction, the terminal receives download disapproval information through the base station 20 and notifies the user that the data cannot be downloaded. If the user agrees to the access restriction, the terminal downloads the data through the base station 20.

As described above, under state that the data having the access restriction information inserted therein are downloaded to the mobile communication terminal 10, if the user of the mobile communication terminal 10 requests an access for the data, the access restriction information inserted in the data is read-out to compare with a current condition of the mobile communication terminal 10.

It can be structured such that if a current position of the mobile communication terminal 10 is within a neighboring range of the accessible area, the terminal provides the user with road guide information so that the user is able to move to the accessible area. On the contrary, if the mobile communication terminal is located in the accessible area, it accesses to the data immediately. If the mobile communication terminal is neither located in the accessible area nor the neighboring range, it notifies the user that the access is impossible.

The base station 20 serves to transmit/receive the data between the mobile communication terminal 10 and the switching apparatus 30.

The switching apparatus 30 can be structured such that it receives and transmits the download request message from the base station 20 to the access restricting apparatus 40 and receives and transmits the question message of whether or not the agreement from the access restricting apparatus 40 to the base station 20. In addition, the switching apparatus 30 receives and transmits the agreement message or refusal message from the base station 20 to the access restricting apparatus 40 and receives and transmits the download disapproval message or download data from the access restricting apparatus 40 to the base station 20. The switching apparatus 30 transmits the position information of the mobile communication terminal 10 to the base station 20 using a position information technology such as Home Location Register (HLR), Visited Location Register (VLR) and the like.

The access restricting apparatus 40 encodes the access restriction information set by an operator and inserts the encoded information into the data being downloaded to the mobile communication terminal 10. When the access restricting apparatus 40 receives the download request message through the switching apparatus 30, it transmits the access restriction information about the requested data to the switching apparatus 30 together with the question message of whether the user agrees to the access restriction. Then, if the access restricting apparatus 40 receives the refusal message through the switching apparatus 30 regarding the question message, it transmits the download disapproval message to the switching apparatus 30. On the contrary, if the access restricting apparatus receives the agreement message through the switching apparatus 30 regarding the question message, it transmits the requested data to the switching apparatus 30.

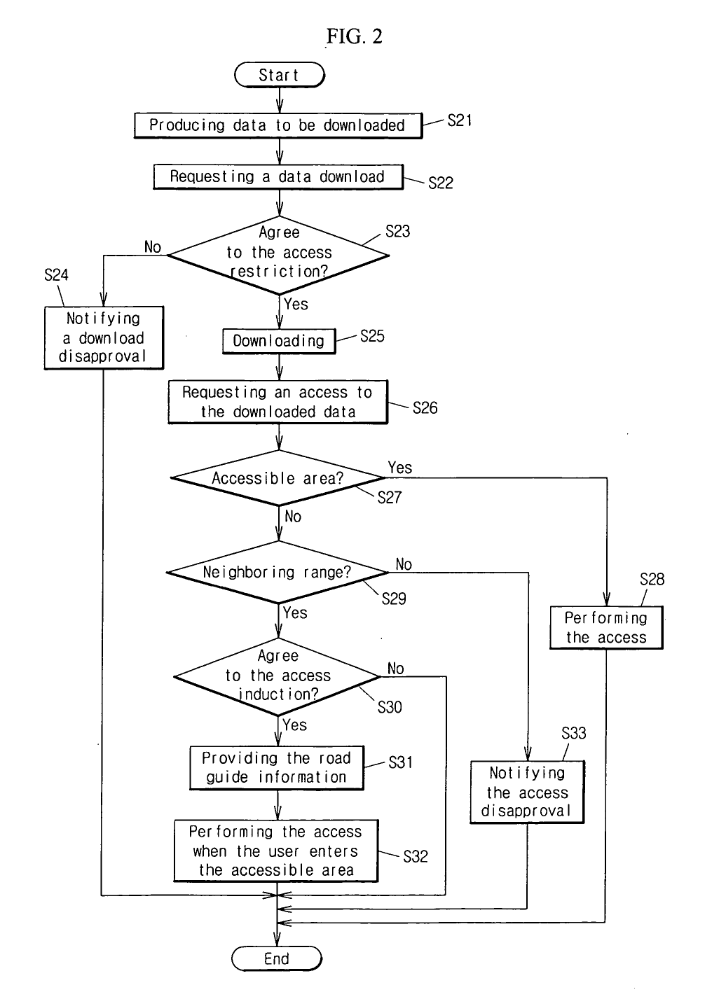

Hereinafter, a data access process according to a first embodiment of the invention will be describe with reference to FIG. 2.

Firstly, access restriction information is inserted into data for which it is intended to restrict an access, thereby producing data to be downloaded (S21). The data may include contents, moving pictures, images, voices, sounds, applications and the like to be downloaded to the mobile communication terminal 10.

In the specification including claims, the access restriction information is the information for restricting an access for the corresponding data regionally or temporally. For example, the access restriction information is set so that an access for certain data is possible only in a specific region or time, wherein the information may include particulars of the specific region or time and information about a neighboring range of the specific region or a neighboring time of the specific time.

In the mean time, the access restriction information may be inserted into the data through the access restricting apparatus 40. For example, an operator of the access restricting apparatus 40 previously specifies a area in which the data can be accessed and a neighboring range of the area and inputs the information of the specified area and neighboring range in the access restricting apparatus 40. The access restricting apparatus 40 encodes the access restriction information (the area information and the neighboring range information) set by the operator and inserts the encoded information in corresponding data, thereby producing the data to be downloaded to the mobile communication terminal 10 (S21).

Under state that the data having the access restriction information inserted therein is produced, when the user of the mobile communication terminal 10 performs a communication connection with the access restricting apparatus 40 through the base station 20 and the switching apparatus 30 to request a download of the data (S22), the access restricting apparatus 40 transmits the access restriction information for the data to be downloaded and the information for asking the user whether the user agrees to the access restriction (i.e., a question message of whether or not the agreement) to the mobile communication terminal 10 via the switching apparatus 30 and the base station 20.

Then, the mobile communication terminal 10 notifies the user of the access restriction information and the question message of whether or not the agreement through the voice output means or image output means and checks a user's reply to the question of whether or not the agreement (S23).

As a result of the check in the step S23, if the user refuses the access restriction, the mobile communication terminal 10 notifies a refusal message to the access restricting apparatus 40, and the access restricting apparatus 40 having received the refusal message transmits a message having a meaning that the corresponding data cannot be provided, i.e., a download disapproval message to the mobile communication terminal 10. Then, the mobile communication terminal 10 recognizes the download disapproval information received through the base station 20 and notifies the user of a message that the corresponding data cannot be downloaded, through the voice output means or image output means (S24).

On the contrary, as a result of the check in the step S23, if the user agrees to the access restriction, the mobile communication terminal 10 notifies a user's agreement message to the access restricting apparatus 40, and the access restricting apparatus 40 having received the agreement message transmits the corresponding data to the mobile communication terminal 10 via the switching apparatus 30 and the base station 20. Then, the mobile communication terminal 10 downloads the data being received through the base station 20 (S25).

After that, when the user requests an access of the downloaded data (S26), the mobile communication terminal 10 reads-out the access restriction information inserted in the corresponding data and checks whether a current position of the mobile communication terminal 10 corresponds to the accessible area included in the access restriction information (S27).

In this case, the current position of the mobile communication terminal may be checked using an area information technology through a Global Positioning System (GPS) or an area information system through the base station 20 or switching apparatus 30.

In addition, it can be structured that the access trial may be performed as soon as the download is completed or the user requests the access after storing the data in an internal memory of the mobile communication terminal.

As a result of the check in the step S27, if the current position of the mobile communication terminal 10 corresponds to the accessible area, the mobile communication terminal 10 performs the access of the data requested (S28).

On the contrary, as a result of the check in the step S27, if the current position of the mobile communication terminal 10 does not correspond to the accessible area, it is checked whether the current position is within the neighboring range of the accessible area or not (S29).

As a result of the check in the step S29, if the current position of the mobile communication terminal 10 is within the neighboring range of the accessible area, the terminal asks the user whether the user wants to have the road guide information for moving the area in which the requested data can be accessible, and checks the user's reply to the question (S30).

As a result of the check in the step S30, if the user agrees to the provision of the road guide information, the terminal provides the user with the road guide information using the area information technology through the GPS or the area information system through the base station 20 or switching apparatus 30 (S31). Then, when the user moves to the accessible area, the terminal performs the access of the requested data (S32).

On the contrary, as a result of the check in the step S30, if the user does not agree to the provision of the road guide information, the access process of the requested data is finished as it is.

In the mean time, if the position of the mobile communication terminal 10 does not correspond to neither the accessible area nor the neighboring range when the user requests the access of the data, the mobile communication terminal 10 notifies the user that the requested data cannot be accessed, through the voice output means or image output means (S33).

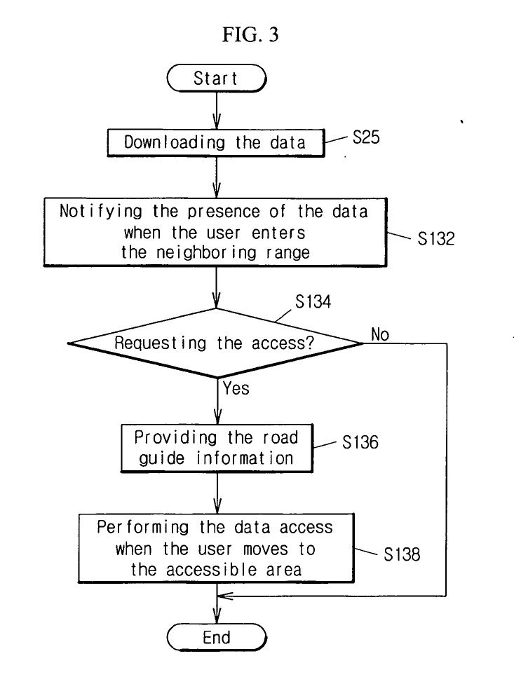

Hereinafter, a method for restricting data access according to a second embodiment of the invention will be described with reference to FIG. 3.

Under state that the data having the access restriction information, i.e., the information about the accessible area and the information about the neighboring range of the area inserted therein is downloaded to the mobile communication terminal 10 (S25), when the mobile communication terminal enters the neighboring range, it notifies the presence of the data to the user, even if the user did not request an access about the downloaded data (S132).

In this case, the mobile communication terminal may be structured such that it checks a position of the terminal every predetermined time interval, and can notify the user of a message asking the user whether the user wants the access of the data, together with the presence of the corresponding data (S134).

If the user having received the notification of the presence of the data requests the access of the data, the terminal provides the user with the road guide information so that the user can move to the accessible area (S136). Then, when the user moves to the accessible area, the terminal performs the access to the data so that the user can use the data (S138).

The processes of inserting the access restriction information to produce the data to be downloaded (S21) and downloading the data (S22˜S25) that have been described in the first embodiment can be also applied to the second embodiment. In addition, similarly to the first embodiment, the position check and the provision of the road guide information of the mobile communication terminal can be carried out using a position search technology such as GPS, HLR, VLR and the like.

In the first embodiment, the access restriction information (information about the accessible area and information about the neighboring range) inserted in the data are read-out and compared with the current position of the mobile communication terminal as the user requests the access of the data. However, in the second embodiment, the access restriction information and the position of the mobile communication terminal are checked every predetermined time interval without the access request.

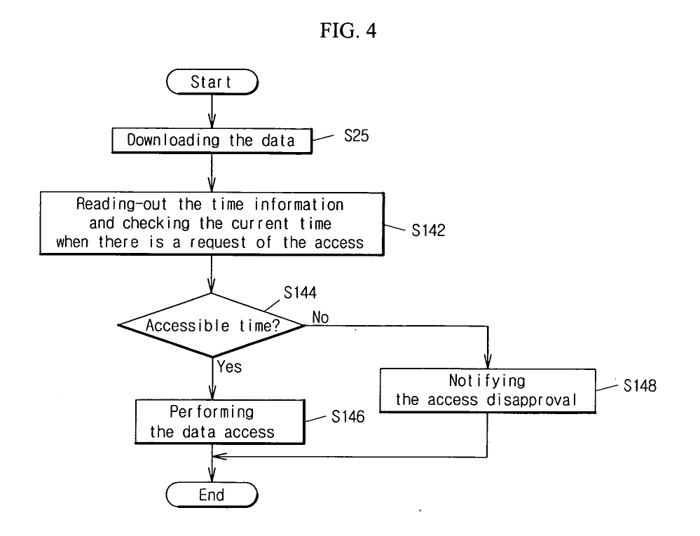

Hereinafter, a method for restricting data access according to a third embodiment of the invention will be described with reference to FIG. 4. The processes of inserting the access restriction information to produce the data to be downloaded (S21) and downloading the data (S22˜S25) that have been described in the first and second embodiments can be also applied to the third embodiment. However, the third embodiment is different from the first and second embodiment in that the access restriction information has information about the accessible time.

Specifically, the data having the accessible time information inserted therein is downloaded to the mobile communication terminal 10 (S25). When the user requests the access of the downloaded data, the terminal reads-out the access restriction information inserted in the data to check the accessible time (S142).

Then, it is checked whether current time corresponds to the accessible time or not (S144). As a result of the check in the step S144, if the current time is the accessible time, the terminal performs the access of the data requested by the user (S146). On the contrary, as a result of the check in the step S144, if the current time does not correspond to the accessible time, the terminal notifies the user that the access is not permitted (S146) and then finishes the access trying process.

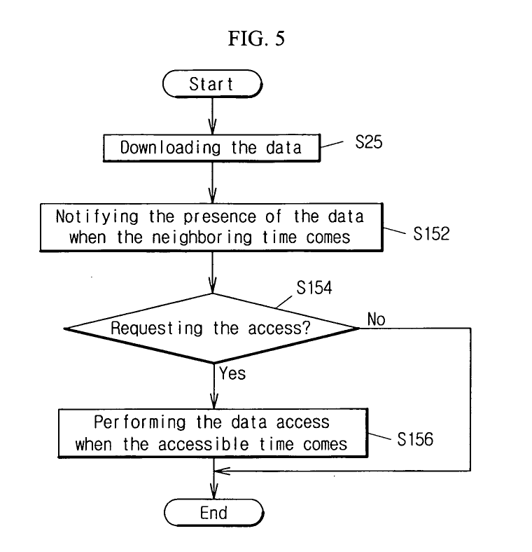

Hereinafter, a method for restricting data access according to a fourth embodiment of the invention will be described with reference to FIG. 5. The processes of inserting the access restriction information to produce the data to be downloaded (S21) and downloading the data (S22˜S25) that have been described in the first and second embodiments can be also applied to the fourth embodiment. However, the fourth embodiment is different from the first and second embodiment in that the access restriction information is temporal restriction information rather than the regional restriction information. In addition, the fourth embodiment is different from the third embodiment in that the terminal notifies the user of whether or not the access of the data when the accessible time or the neighboring time of the accessible time comes, even if the user did not request an access about the downloaded data.

Specifically, the data having the accessible time information and the neighboring time information inserted therein are downloaded to the mobile communication terminal (S25). When the neighboring time comes, the mobile communication terminal notifies the user of the presence of the data through the voice output means or image output means (S152). In this case, the terminal can also notify the user of the question asking the user whether the user wants to try the access to the data or not.

Then, it is checked whether there is an access request from the user having received the notification of the step S152 (S154). As a result of the checked in the step S154, if there is the access request from the user, the terminal performs the access to the data as the accessible time comes.

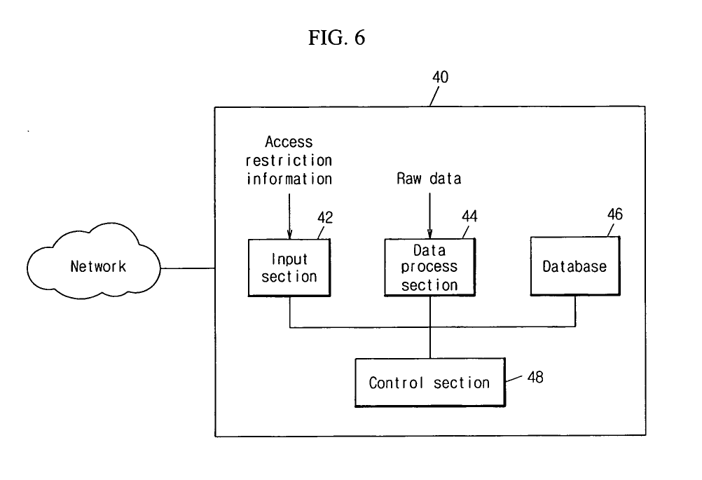

Hereinafter, an apparatus for restricting data access according to another aspect of the invention will be described with reference to FIG. 6. As shown in FIG. 6, the data access restricting apparatus 50 according to an embodiment of the invention may comprise an input section for inputting access restriction information; a data process section for encoding and inserting the access restriction information received from the input section into data for which it is intended to restrict an access; a database for storing the data having the access restriction information inserted therein; and a control section for extracting and transmitting the data having the access restriction information inserted therein, when it is requested a download for the data, from the database to a mobile communication terminal having requested the download.

In this case, the data having the access restriction information inserted therein is able to be accessed only in case an access condition included in the access restriction information is satisfied, when an access to the data is requested.

The input section 42 is an element for inputting the access restriction information in the access restricting apparatus 40 when it is intended to restrict an access to certain data. For example, the input section may include diverse inputting means such as keyboard, mouse and the like.

As a type of the access restriction, temporal or regional information may be included in the access restriction information as described above. For example, it can be set such that the access is permitted for a predetermined time or in a predetermined area only.

The data process section 44 performs functions of encoding and then inserting the access restriction information, which was inputted through the input section 42, into the corresponding data. The reason to insert the encoded access restriction information into the data is so that the access of the data is to be possible only when the condition included in the access restriction information is satisfied.

The database 46 performs a function of storing the data having the access restriction information inserted therein.

The control section 48 performs functions of reading-out and transmitting the data, when it is requested a download for the data from the mobile communication terminal 10 (refer to FIG. 1), from the database 46 to the mobile communication terminal 10 having requested the download.

The transmission of the data to the mobile communication terminal 10 may be structured as follows: firstly, the user of the mobile communication terminal 10 is previously notified that an access to the data is restricted and is asked a question of whether or not the agreement to the restriction. After that, the data can be transmitted only when the user agrees to the access restriction.

When it is tired an access to the data downloaded according to the above manner, it is checked whether the time or position in trying the access satisfies the conditions included in the access restriction information. Only when the condition is satisfied, the access is performed.

The access restricting apparatus 40 may perform a communication with the switching apparatus, the base station and the mobile communication terminal through a network (refer to FIG. 1).

The above method and apparatus of restricting the data access of the invention can be applied diverse fields. For example, it is possible to provide the audiences waiting for a movie showing at a theater with a download service using the access restricting method of the invention for additional information of the movie to be shown (for instance, history, award careers and other performance productions of the director and actors). In this case, certified numbers for the download may be written on a movie ticket in advance and it can be set such that the access to the additional information downloaded to the mobile communication terminal cannot be performed during the movie showing or at the outside of the theater.

In addition, it is possible to the patients waiting for a medical treatment at the hospital with diverse images or music files through a download service using the access restricting method of the invention, during the waiting of treatment orders. In this case, treatment receipt numbers can be used as the certified numbers for the download, and it can be set such that the access to the images or music files downloaded to the mobile communication terminal cannot be performed beyond a predetermined time or at the outside of the hospital.

As described above, according to the invention, it is possible to access the specific data downloaded to the mobile communication terminal or a mobile information device or existing therein only for a permitted time or at a permitted region. Accordingly, it is possible to improve a use efficiency of the data by inducing the user into a time or space in which the user can use the downloaded data as well as to protect a right to use the data by restricting the use of the data temporally or regionally.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for restricting data access comprising processes of:
downloading data having information about an accessible area and information about a neighboring range of the area inserted therein to a mobile communication terminal;
reading-out the area information and the neighboring range information from the data and checking a current position of the mobile communication terminal when a user requests an access for the downloaded data; and
accessing to the data if the mobile communication terminal is located on the accessible area as a result of the check.

2. The method according to claim 1, wherein the area information and the neighboring range information are inserted in the data.

3. The method according to claim 1, wherein the mobile communication terminal downloads the data only when the user having checked the area information agrees to the download.

4. The method according to claim 1, further comprising a process of providing the user with road guide information so that the user is able to move to the accessible area if the mobile communication terminal is located on the neighboring area as a result of the check.

5. The method according to claim 4, wherein the check of the current position and the provision of the road guide information of the mobile communication terminal are performed through a position search function provided to the mobile communication terminal.

6. The method according to claim 4, further comprising a process of accessing to the data when the user moves to the accessible area after the provision of the road guide information.

7. The method according to claim 1, further comprising a process of notifying the user that the access to the data is impossible when the mobile communication terminal is neither in the accessible area nor the neighboring range as a result of the check.

8. A method for restricting data access comprising processes of:
downloading data having information about an accessible area and information about a neighboring range of the area inserted therein to a mobile communication terminal;
notifying the presence of the data to a user when the mobile communication terminal having the data downloaded thereto enters the neighboring range; and
accessing to the data when the user moves to the accessible area.

9. The method according to claim 8, wherein the area information and the neighboring range information are inserted in the corresponding data.

10. The method according to claim 8, wherein the mobile communication terminal downloads the data only when the user having checked the area information agrees to the download.

11. The method according to claim 8, further comprising a process of providing the user with road guide information so that the user is able to move to the accessible area, when the user having received the notification of the presence of the data requests an access of the data.

12. The method according to claim 11, wherein a check of whether or not the entry into the neighboring range and the provision of the road guide information of the mobile communication terminal are performed through a position search function provided to the mobile communication terminal.

13. The method according to claim 8, further comprising a process of checking whether the mobile communication terminal enters the neighboring range at a predetermined time interval.

14. A method for restricting data access comprising processes of:
downloading data having information about an accessible time inserted therein to a mobile communication terminal;
reading-out the time information inserted in the corresponding data to check a current time when a user requests an access for the downloaded data; and
accessing to the data when the current time corresponds to the accessible time as a result of the check.

15. The method according to claim 14, wherein the time information is inserted in the corresponding data.

16. The method according to claim 14, wherein the mobile communication terminal downloads the data only when the user having checked the time information agrees to the download.

17. A method for restricting data access comprising processes of:
downloading data having information about an accessible time and information about a neighboring time of the accessible time inserted therein to a mobile communication terminal;
notifying the presence of the data to a user when the neighboring time comes; and
accessing to the data when the accessible time comes, if the user having received the notification of the presence of the data requests an access of the data.

18. The method according to claim 17, wherein the accessible time information and the neighboring time information are encoded and inserted in the corresponding data.

19. The method according to claim 17, wherein the mobile communication terminal downloads the data only when the user having checked the accessible time information agrees to the download.

20. An apparatus for restricting data access comprising:
an input section for inputting access restriction information;
a data process section for encoding and inserting the access restriction information received from the input section into data for which it is intended to restrict an access;
a database for storing the data having the access restriction information inserted therein; and
a control section for extracting and transmitting the data having the access restriction information inserted therein, when it is requested a download for the data, from the database to a mobile communication terminal having requested the download, wherein the data having the access restriction information inserted therein is able to be accessed only in case an access condition included in the access restriction information is satisfied, when an access to the data is requested.

21. The apparatus according to claim 20, wherein the access restriction information is area restriction information set so that it is able to be accessed in a predetermined region only.

22. The apparatus according to claim 20, wherein the access restriction information is time restriction information set so that it is able to be accessed for a predetermined time only.
